(19) United States
(12) Patent Application Publication
(10) Pub. No.: US 2025/0389411 A1
(43) Pub. Date: Dec. 25, 2025

(54) LIGHTING DEVICE

(71) Applicant: Streamlight, Inc., Eagleville, PA (US)

(72) Inventors: W. Ross McLennan, Perkasie, PA (US); Thomas D. Boris, Collegeville, PA (US); Thomas J. Kelley, Hartland, WI (US)

(73) Assignee: Streamlight, Inc., Eagleville, PA (US)

(21) Appl. No.: 19/191,863

(22) Filed: Apr. 28, 2025

Related U.S. Application Data
(60) Provisional application No. 63/662,503, filed on Jun. 21, 2024.
(60) Provisional application No. 63/709,764, filed on Oct. 21, 2024.

(51) Int. Cl. F21V 19/04; F21L 4/00; F21V 23/04; F21Y 113/00; F21Y 115/10

(52) U.S. Cl. CPC F21V 19/04; F21L 4/005; F21V 23/0442; F21Y 2113/00; F21Y 2115/10

(57) ABSTRACT

Improvements in portable lighting devices are shown and described. These improvements include new arrangements for the configuration of battery compartments to allow for different types of battery sources to be used therein, use of electromagnetic position sensing for a mode selection or other type of switch, selector, or dial, and improvements relating to venting of a battery compartment.

### CROSS-REFERENCE TO RELATED APPLICATIONS

The present application claims domestic benefit to and hereby incorporates by reference for all purposes the entireties of each of U.S. Provisional Application No. 63/662,503, filed Jun. 21, 2024 and entitled “BATTERY ASSEMBLY,” and U.S. Provisional Application No. 63/709,764, filed Oct. 21, 2024 and entitled “LIGHTING DEVICE”. In addition, U.S. Design Patent Application No. 29/969,158, filed Oct. 21, 2024 and entitled “LIGHTING DEVICE”, is incorporated herein by reference for all purposes.

### FIELD OF THE DISCLOSURE

The present disclosure relates to the field of portable lighting devices.

### BACKGROUND

Although portable lighting devices with pivoting light heads are well known, there is continued need for improvements in this field of art. Several improvements in this field are the subject of the present disclosure, including for example improved arrangements for the configuration of battery compartments to allow for different types of battery sources to be used therein, improvements relating to electromagnetic position sensing for a mode selection or other type of switch, selector, or dial, and improvements relating to venting of a battery compartment.

### BRIEF DESCRIPTION OF THE DRAWINGS

The devices according to the present disclosure are further described with reference to the accompanying drawings, in which:

FIG. 1 is a front, left perspective view of an embodiment of a lighting device according to the present disclosure;

FIG. 2 is a front, right perspective view thereof;

FIG. 3 is a front, left perspective view thereof, with a head portion containing a light source thereof in an alternative configuration;

FIG. 4 is a sectional view taken along line 4-4 of FIG. 2, showing the interiors of a battery compartment, a rotational joint, and the head portions thereof;

FIG. 5 is a sectional view taken along line 5-5 of FIG. 2, shown at a perspective angle;

FIG. 6 is a sectional view taken along line 6-6 of FIG. 2;

FIG. 7 is a bottom perspective view of the lighting device of FIG. 1, with a removeable cover for the battery compartment shown open and the battery compartment containing a first battery type, in particular two AA-sized batteries;

FIG. 8 is a bottom perspective view thereof with the battery compartment containing a second battery type, in particular one CR123-sized battery;

FIGS. 9 and 10 are perspective views of battery contact subassemblies of the lighting device of FIG. 1, shown in isolation;

FIG. 11 is a close-up view of approximately the area labeled 11-11 in FIG. 6, showing a sealing assembly between the battery compartment and the removeable battery compartment cover;

FIG. 12 is a close-up view of approximately the area labeled 12-12 in FIG. 4, showing details of a rotatable light mode selector assembly;

FIG. 13 is a side view of the light head of FIG. 1 and a rotatable light mode selector assembly of the lighting device of FIG. 1, with a portion of the light head hidden from view for discussion purposes;

FIG. 14 is a close-up view of approximately the area labeled 14-14 in FIG. 4, showing details of the rotational joint including a spring clip and a twisted wire pair;

FIG. 15 is a sectional view taken along line 15-15 of FIG. 2, showing details of the rotational joint;

FIG. 16 is a close-up view of approximately the area labeled 16-16 in FIG. 15, showing details of a seal and gas release port;

FIGS. 17A-17C show various boots that fit over the button of the rotatable selector to indicate the various light modes possible by the lighting device of FIG. 1;

FIG. 18 is a front, right perspective view of another embodiment of a lighting device according to the present disclosure;

FIG. 19 is a rear, left perspective view thereof;

FIG. 20 is a sectional view taken along line 20-20 of FIG. 18, showing interiors of a battery compartment and head portions thereof;

FIG. 21 is a sectional view taken along line 21-21 of FIG. 18; and

FIG. 22 is a close-up view of approximately the area labeled 22-22 in FIG. 20, showing a sealing assembly between the battery compartment and a removeable battery compartment cover.

### DETAILED DESCRIPTION

The ensuing detailed description provides exemplary embodiment(s) only, and is not intended to limit the scope, applicability, or configuration of the herein disclosed embodiment(s). Rather, the ensuing detailed description of the exemplary embodiment(s) will provide those skilled in the art with an enabling description for implementing the exemplary embodiments in accordance with the present disclosure. It should be understood that various changes may be made in the function and arrangement of elements without departing from the spirit and scope of the invention, as set forth in the appended claims.

To aid in describing the disclosure and/or invention as claimed, directional terms may be used in the specification and claims to describe portions of the present disclosure and/or invention (e.g., upper, lower, left, right, etc.). These directional definitions are merely intended to assist in describing the embodiment(s) and claiming the invention, and are not intended to limit the disclosure or claimed invention in any way. In addition, reference numerals that are introduced in the specification in association with a drawing figure may be repeated in one or more subsequent figures without additional description in the specification, in order to provide context for other features.

It should be understood that when an element is referred to as being “connected” or “coupled” to another element, it can be directly connected or coupled to the other element or that intervening elements may be present. In contrast, when an element is referred to as being “directly connected” or “directly coupled” to another element, it should be understood that no intervening elements are present. Other words used to describe the relationship between elements should be interpreted in a like fashion (e.g., “between” versus “directly between,” “adjacent” versus “directly adjacent,” etc.).

In embodiment(s) described herein or shown in the drawings, any direct electrical connection or coupling, i.e., any connection or coupling without additional intervening elements, may also be implemented by an indirect connection or coupling, i.e., a connection or coupling with one or more additional intervening elements, or vice versa, as long as the general purpose of the connection or coupling, for example, to transmit a certain kind of signal or to transmit a certain kind of information, is essentially maintained. Features from different embodiment(s) may be combined to form further embodiment(s). For example, variations or modifications described with respect to one of the embodiment(s) may also be applicable to other embodiment(s), unless noted to the contrary.

For purposes of the present specification and claims, the term “liquid resistant” shall have the meaning of being able to partially or completely prevent, delay, or lessen to any degree or extent the ingress of liquids (e.g., water) under certain conditions. “Liquid resistant” may include but is not limited to the ability to meet one or more of various relevant technical standards, such as liquid ingress protection (IP) ratings defined by the International Electrotechnical Commission (IEC) under the international standard IEC 60529, for example one or more of IPX1-IPX9 ratings for preventing liquid ingress.

Portable lighting devices, including those with light heads that are attached in a rotational arrangement with respect to a body thereof, are well known in the art. Examples include the Sidewinder family of lights manufactured and sold by Streamlight, Inc. of Eagleville, Pennsylvania, U.S.A., which is the applicant of the present application. Some of these prior art devices are “dual fuel” devices that can be alternatively powered by either of two different battery types based on the availability of batteries, for example AA-or CR 123-sized batteries. U.S. Pat. No. 8,779,683, which is incorporated herein by reference in its entirety for all purposes, teaches circuitry for a lighting device that is alternatively powerable by two different types of batteries. Moreover, a previous example of a multi-battery cavity is included in Streamlight, Inc.'s Sidewinder Compact II product, which is covered by U.S. Pat. No. 8,727,561, the entirety of which is incorporated herein by reference for all purposes. In one respect, the present disclosure teaches improvements in the support, arrangement, and contact means for a “dual fuel” type of portable lighting device, i.e., one capable of being powered by more than one type of battery without reconfiguration.

A previous version of the rotatable light head concept is shown in Streamlight, Inc.'s “Sidewinder Boot” product and described in U.S. Pat. No. 10,948,139, the entirety of which is incorporated herein by reference for all purposes. Previous versions of a rotatable light mode selector switch appear on products in Streamlight, Inc.'s family of Sidewinder-branded products and are described in detail in U.S. Pat. No. 7,549,766, the entirety of which is incorporated herein by reference for all purposes. In another respect, the present disclosure teaches improvements in a rotatable light mode selector/switch, as will be described below.

U.S. Pat. No. 10,948,139, the entirety of which is incorporated herein by reference for all purposes, teaches other features of a portable light with a rotatable light head portion. The present disclosure includes several improvements over that device, as will be described in detail below.

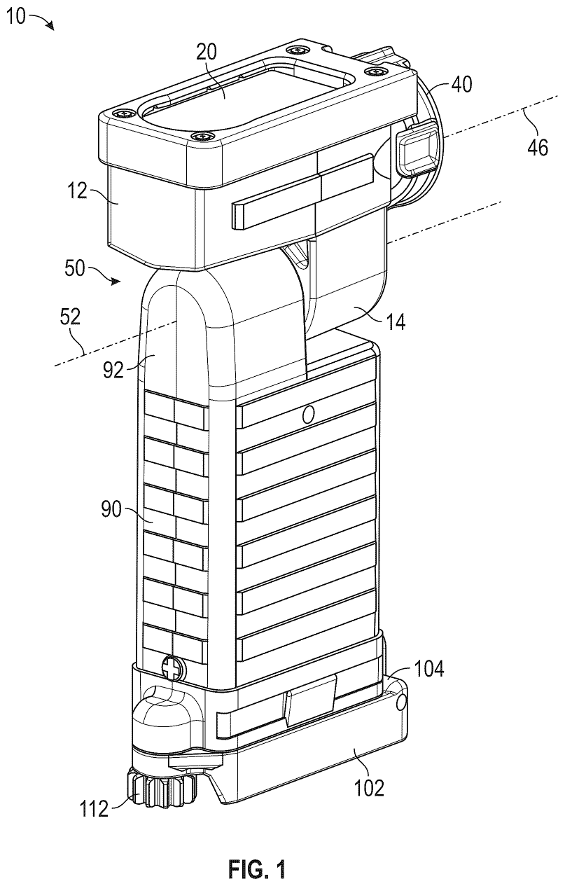

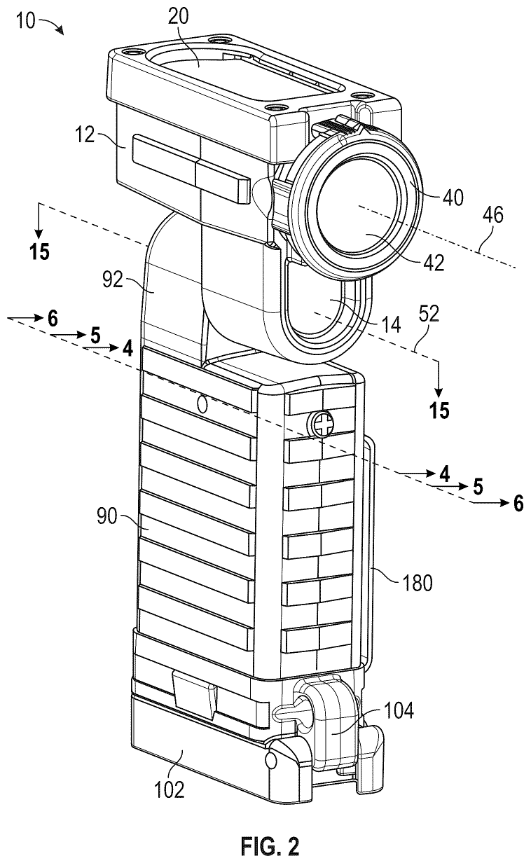

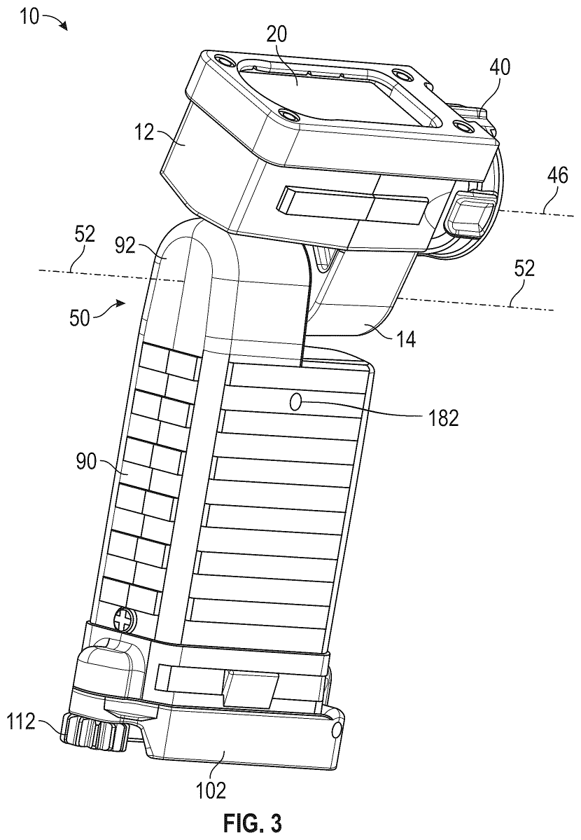

Turning now to FIGS. 1-16, a lighting device 10 according to a first embodiment of the present disclosure will be described in detail. With specific reference to FIGS. 1-3, the lighting device 10 includes a body 90 which serves as a battery housing, a light head 12 or housing which contains one or a plurality of light source(s) 20, and a rotation joint 50 that rotatably connects the light head 12 to the body 90 about a rotation axis 52. Each of the body 90 and light head 12 contains respective connection portion 14, 92 that are joined together to form the rotation joint 50. The connection portions 14, 92 can be rotated relative to one another to position the light head 12 at a desired angle (e.g., as shown in FIG. 3) with respect to the body 90. The light head 12 includes a rotatable selector 40 (e.g., a rotatable light mode selector) that allows for selection of a mode of the light source 20. The rotatable selector 40 can also include a button 42 or switch (e.g., as shown in FIG. 2) which may be depressible to turn the light source 20 on or off and/or to change other features of the light source 20 (e.g., intensity, mode, or color). The rotatable selector 40 can be rotated about a rotation axis 46 to change settings of the light source 20 (e.g., mode, color, brightness, or states such as solid or flashing). As shown in FIG. 2, the lighting device 10 includes a clip 180 attached to the body 90. In some examples, the clip 180 can be used to attach the lighting device 10 to a user's clothing (e.g., a belt, a cap, or a jacket) or to an external object. In this embodiment, the clip 180 is removably attached to the body 90 via a fastener (not shown), which can be removed such that the clip 180 can be relocated and attached to the opposite side of the body 90 to change the handedness of the lighting device 10 via hole 182 (i.e., there is an identical hole located on the opposite side of the body 90). Further, some examples of the lighting device 10 can include an optical element (e.g., a focuser, not shown) that is attached to the light head 12—optionally in a slideable configuration—to create a more focused beam of light that is emitted from the light source 20.

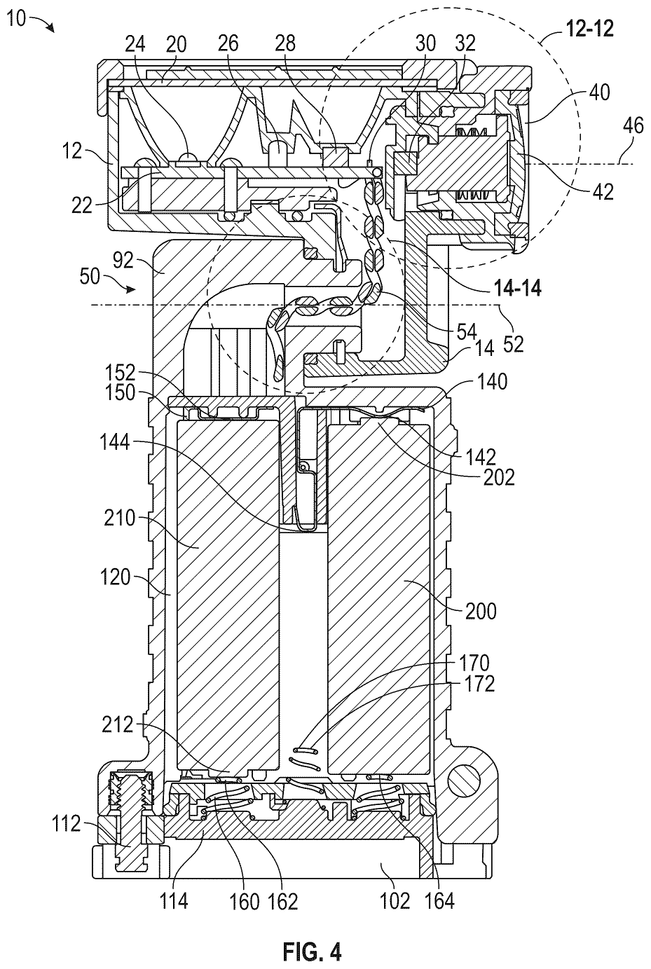

At the bottom of the body 90 is a battery cover 102 that is rotatably attached to the body 90 via a hinge 104 between open and closed configurations. In this embodiment, a fastener 112 comprising a thumb wheel and a threaded fastener portion can be used to secure the battery cover 102 to the body 90 (see FIG. 4) in its closed configuration to prevent accidental opening of the battery cover 102. When the fastener 112 is loosened, the battery cover 102 may be rotated via the hinge 104 to reveal a battery compartment 120 located within an interior of the body 90. As will be further discussed below, the battery cover 102 contains a biasing mechanism (in the form of seal 106) that lightly presses the battery cover 102 open when the fastener 112 is loosened.

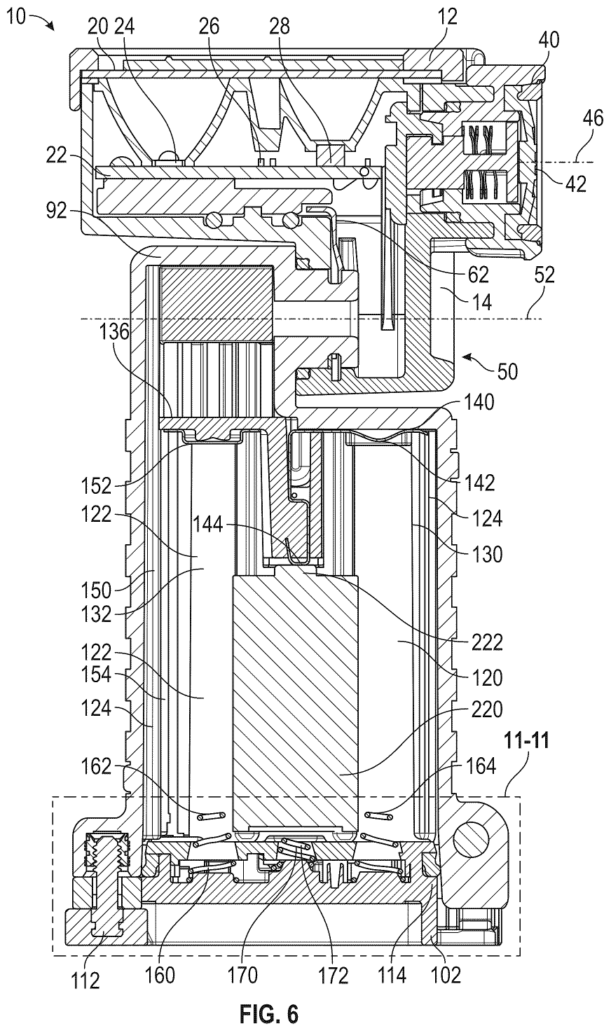

Several of the improvements of the lighting device 10 according to the present disclosure relate to the arrangement of the battery compartment 120 and battery contacts located therein for both performance improvement and ease of alternatively using two different types of batteries based on availability or preference (i.e., in this embodiment, two AA-sized batteries or one CR123-sized battery). In particular, with reference generally to FIGS. 4-11, the lighting device 10 according to this embodiment includes several improved features. FIG. 4 is a sectional view taken through the body 90 and the light head 12 along line 4-4 of FIG. 2 showing the internal parts of the lighting device 10. The body 90 includes the battery compartment 120 that is accessible by opening the battery cover 102, with some elements embedded in the battery cover 102 itself which serves, while the battery cover 102 is in its closed configuration, as part of the functioning electrical circuit for the battery(-ies), as will be discussed below. In this embodiment, as shown in FIGS. 4-8, the battery compartment 120 includes first battery type slots 130, 132 and a second battery type slot 134 that are each sized and shaped to receive, support, and align different types of batteries with respective contact points. For example, as shown in FIG. 4, the first battery type slots 130, 132 each receive a unit of first battery type 200, 210 (i.e., in this embodiment, two AA-sized batteries). FIG. 6 illustrates a second battery type 220 (i.e., in this embodiment, one CR123-sized battery) that is receivable in the second battery type slot 134. Further, the battery compartment 120 can include various ribs 124 that assist with seating, aligning, and maintaining either the first battery types 200, 210 or the second battery type 220 in a stable, desired position within the battery compartment 120.

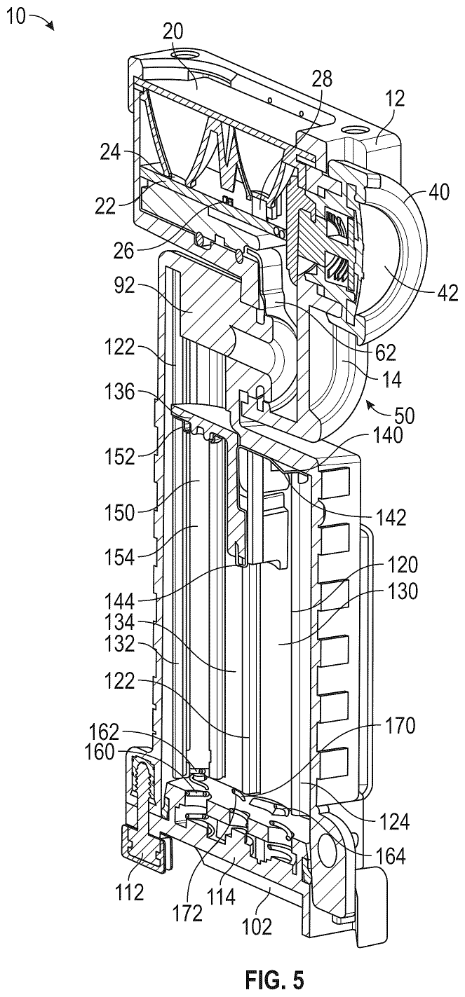

As best illustrated in FIGS. 5-8, the first battery type slots 130, 132 and the second battery type slot 134 are defined by ribs 124 that extend along sidewalls 122 (e.g., interior sidewalls) of the battery compartment 120. The ribs 124 are spaced apart to form the first battery type slots 130, 132 and/or the second battery type slot 134 with desired dimensions according to the battery types (in this example, AA-and CR123-sized batteries) that are to be accommodated within the battery compartment 120. Accordingly, the ribs 124 can assist with maintaining the first battery types 200, 210 and/or the second battery type 220 in proper configuration and/or in engagement with appropriate battery contact points. While the illustrated examples show two slots for a first battery type and one slot for a second battery type, different embodiments according to the present disclosure can include a different number of slots for different battery types. The disclosed example further demonstrates that the compartment can accommodate a different number of batteries of the first type (for example, two AA batteries) as compared to the number of batteries of the second type (for example, one CR123 battery). Further, while the current embodiment(s) discuss lighting device(s) designed to accommodate AA-and CR123-sized batteries, it should be appreciated that the geometry and/or design of the battery compartment in additional embodiments according to the present disclosure may be modified to accommodate these or other known or hereafter-developed battery sizes and/or shapes, either alone or in various configurations of an alternative “multi-fuel” device, such as for example, a dual fuel battery assembly disclosed in U.S. Provisional Application No. 63/662,503, filed Jun. 21, 2024 and entitled “BATTERY ASSEMBLY.”

In one respect, the present application can be considered to disclose a lighting device comprising a light source and a battery compartment electrically connected to the light source, the battery compartment adapted to alternatively receive a first number—equal to or greater than one-of units of a first battery type, or a second number—equal to or greater than one—of units of a second battery type, wherein the first number and the second number are not identical, and wherein the first battery type and the second battery type are electrically connected to the light source through at least one non-identical contact point. In another respect, the present application can be considered to disclose such a lighting device, wherein the first number of units is one and the second number of units is two.

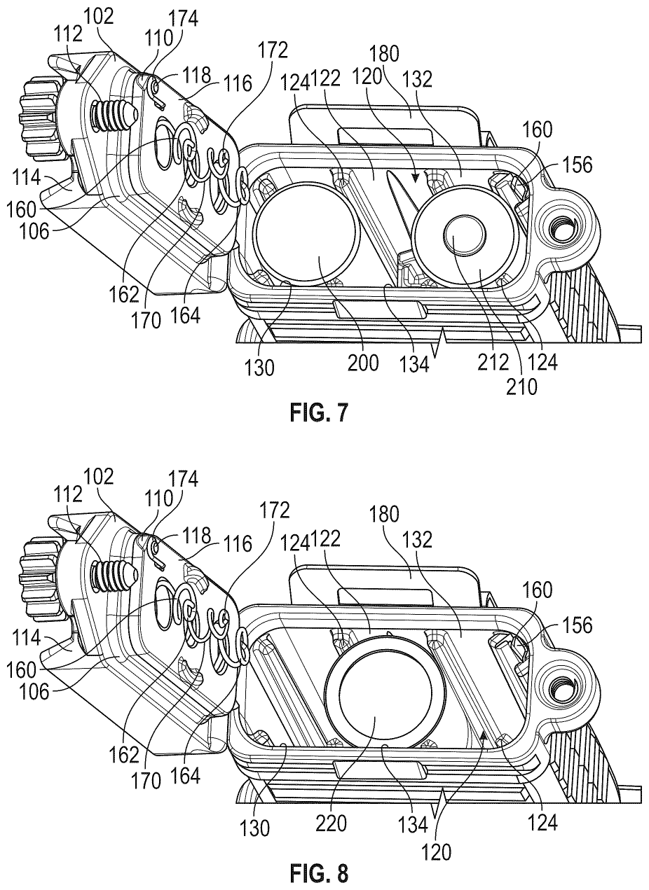

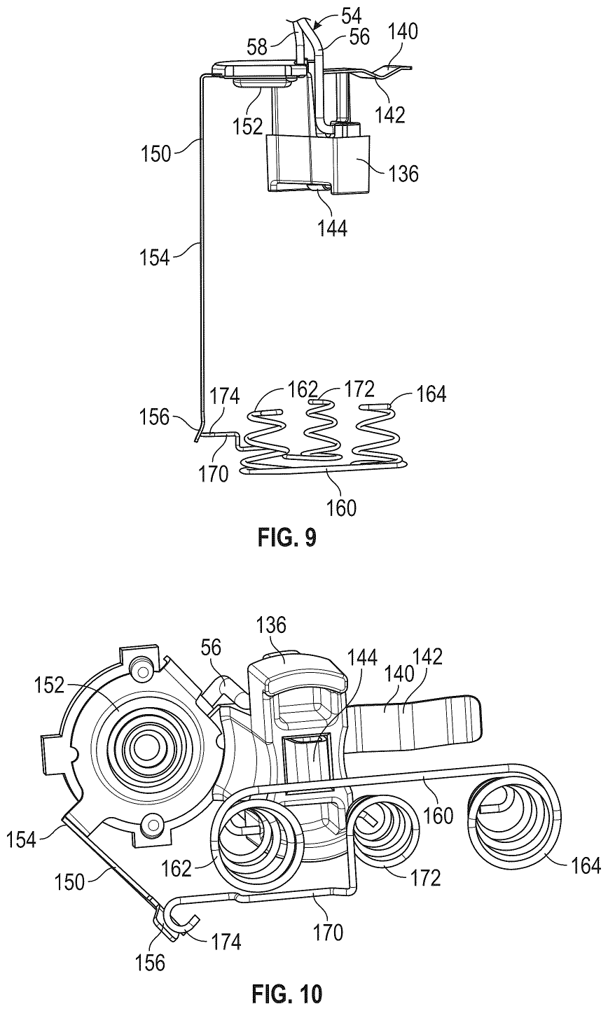

Turning back to the present embodiment, the units of the first battery types 200, 210 or the second battery type 220 can provide power to the light source 20 via multiple contact extenders, which act to electrically connect the individual battery contacts together to complete a circuit with a printed circuit board (PCB) 22 and/or the light source 20, as will be further discussed below. As shown in FIGS. 4-6, a support piece 136-which in this embodiment is located at an upper end of the battery compartment 120-is provided within the battery compartment 120 to support contact extenders 140, 150 and a wire set 54. The contact extender 140 includes and electrically connects together a positive contact point 142 for the first unit of the first battery type 200 and a positive contact point 144 for the unit of the second battery type 220. The contact extender 150 includes a negative contact point 152 for the second unit of the first battery type 210. Further, additional contact extenders 160, 170 are supported on or located in the battery cover 102. In this example, the contact extenders 160, 170 are embedded within a body 114 of the battery cover 102. The contact extender 160 includes and electrically connects together a negative contact point 164 for the first unit of the first battery type 200 and a positive contact point 162 for the second unit of the first battery type 210. In addition, the contact extender 170 includes a negative contact point 172 for the unit of the second battery type 220. Accordingly, when the first battery types 200, 210 are inserted into the battery compartment 120 (e.g., as shown in FIGS. 4 and 7), a positive terminal 202 of the first unit of the first battery type 200 can contact the positive contact point 142, and a positive terminal 212 of the second unit of the first battery type 210 can contact the positive contact point 162. Alternatively, when the unit of the second battery type 220 is inserted into the battery compartment 120 (e.g., as shown in FIGS. 6 and 8), a positive terminal 222 of the second battery type 220 can contact the positive contact point 144. As shown in FIG. 9, the contact extender 140 is connected to a positive wire 56 of the wire set 54, and the contact extender 150 is connected to a negative wire 58 of the wire set 54. Therefore, when terminals of the units of the first battery types 200, 210 or the unit of the second battery type 220 are in contact with corresponding contact points, a battery circuit can be completed to provide power to the PCB 22 and/or the light source 20.

In particular, a battery circuit for the second battery type 220 can be completed by extending the negative contact point 172 for the second battery type 220 to one of the negative contact points (e.g., contact point 152 for the second unit) of the first battery type 210, in this embodiment via a two-part intermittent-contact arrangement, as further described below. In particular, the contact extender 170 can be positioned to contact the contact extender 150-which is connected to the negative wire 58-when the battery cover 102 is sufficiently closed (which can be a partial or full closure of the battery cover 102). In another respect, the contact extender 150 and the contact extender 170 can be considered as two portions of one contact extender (not separately labeled), the two portions being alternatively electrically connected together or disconnected based on a position of the battery cover 102 (i.e., are electrically connected together when physically in contact when the battery cover 102 is sufficiently closed, and disconnected when physically separated when the battery cover 102 is sufficiently opened). In the illustrated example, the contact extender 150 includes a leg 154 that is embedded along the sidewalls 122 of the battery compartment 120. The leg 154 includes a tab 156 (e.g., an additional or separate portion having a curved or angled surface) located at a distal end of the leg 154. Further, the contact extender 170 includes a hooked portion 174 that is designed to engage with the tab 156, thereby achieving a “wiping contact”—as would be understood by one of ordinary skill in the art—when the tab 156 and hooked portion 174 are brought into contact when the battery cover 102 is sufficiently closed. In this embodiment, the contact extender 170 is located within the body 114 of the battery cover 102, and the hooked portion 174 extends outwardly from a corner of the battery cover 102 so that it can physically contact the tab 156. Further, an interior bottom 116 of the battery cover 102 can include a protrusion 118, which anchors the hooked portion 174 in place on the battery cover 102 and prevents it from being bent or otherwise damaged, and an angled surface 110 that provides clearance for the tab 156 between the interior bottom 116 and the sidewalls 122. Accordingly, when the battery cover 102 is suitably closed from an open configuration (e.g., as shown in FIGS. 7 and 8), the interior bottom 116 can at least partially extend into the battery compartment 120, and the hooked portion 174 can align and come into contact with the tab 156.

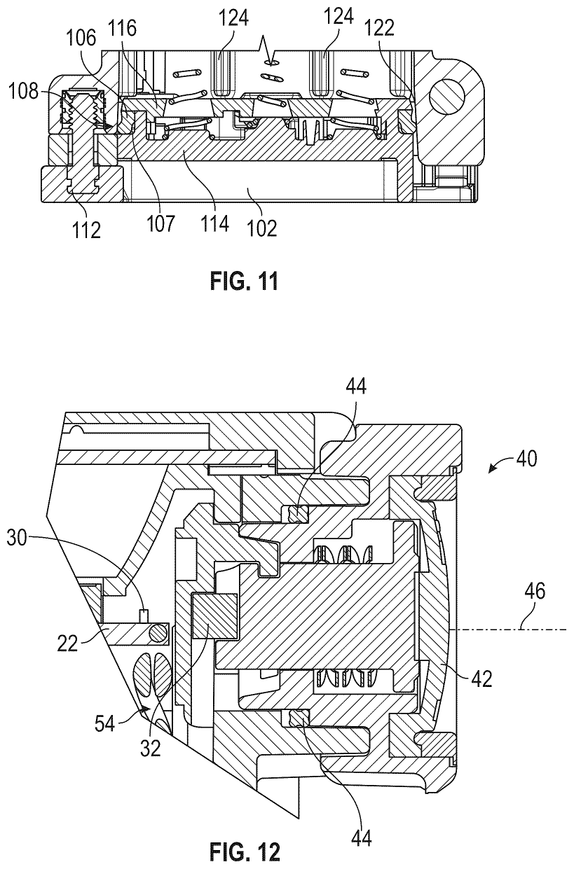

With reference to FIG. 11, the battery compartment 120 of the present embodiment of the lighting device 10 includes a seal 106 attached to the interior bottom 116 of the battery cover 102. The seal 106 contains a sealing lip 108 shaped to deform and press into the sidewalls 122 of the battery compartment 120 to help seal the battery compartment 120 and achieve a desired ingress protection rating(s) for dust and/or liquid resistance(s) (e.g., an IPX7 rating) for the lighting device 10, while simultaneously creating a seal that easily releases the battery cover 102 from the battery compartment 120 when a user desires to open the battery cover 102. A slight air gap 107 is located behind the seal 106 that allows the seal 106 to be compliant (i.e., remain deformable). The seal 106 can be comprised of an elastomeric material (e.g., rubber, nylon, silicone, etc.), which allows the seal 106 to remain compliant and deform with minimal contact with the sidewalls 122 of the battery compartment 120 and then self-seal when liquids attempt to enter the battery compartment 120 from an exterior of the lighting device 10. While the present lighting device 10 is designed to be liquid resistant with a rating of IPX7, other embodiments of lighting devices according to the present disclosure may have a rating of IPX3, IPX4, IPX5, IPX6, IPX7, IPX8, IPX9, or any combination thereof. (However, as stated previously, liquid resistance does not require compliance with any particular technical rating or standard.)

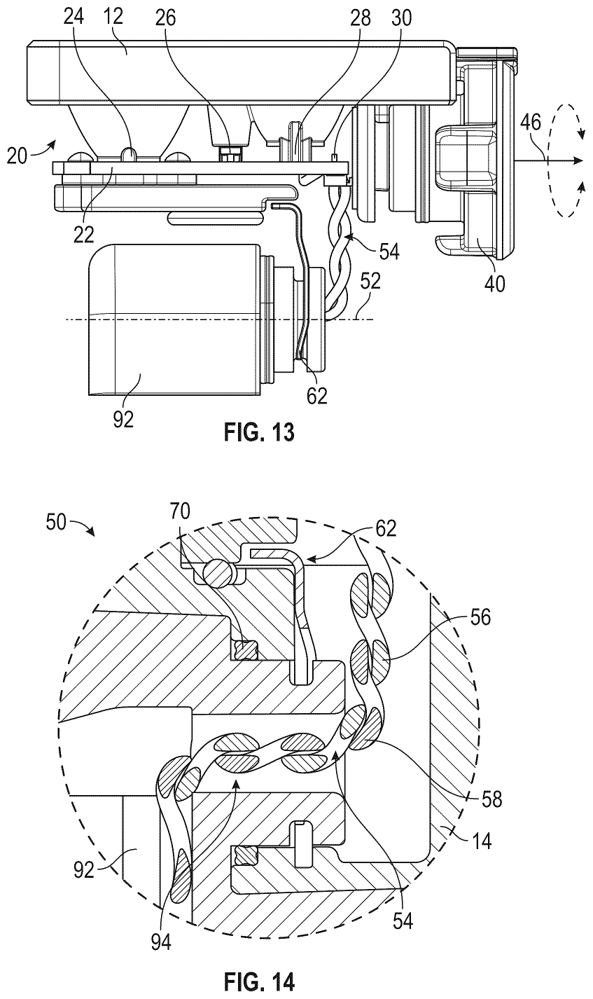

Referring now to FIGS. 12-14 and as discussed above, the wire set 54 extends between the battery compartment 120 and the PCB 22. The wire set 54 is pre-wound (e.g., twisted), which allows for a durable, reliable connection of the positive wire 56 and the negative wire 58 while permitting rotation of the light head 12 approximately 200 degrees around the rotation axis 52. In this embodiment, the wire set 54 extends through a channel 94 that is formed between the connection portion 92 and the connection portion 14. As shown in FIGS. 13 and 14, the connection portion 92 supports a spring clip 62 that helps to secure the connection between the body 90 and the light head 12. In this embodiment the spring clip 62 is a single piece of deformable material (e.g., metal or plastic) that includes multiple bends that create inherent spring forces, which act to hold the light head 12 to the body 90, provide rotational force to the rotation joint 50, and/or help compensate for wear on the rotation joint 50.

Turning back to FIG. 12, the rotatable selector 40 is connected to the light head 12 and a seal ring 44 is provided between the rotatable selector 40 and the light head 12. In this embodiment, the rotatable selector 40 allows for selection between different modes of operation of the light source 20, for example white/infrared/UV/visible blue/visible green, and/or visible red light modes, as will be described in further detail below. In the present embodiment, one improvement over the prior art is the use of a sensor 30 (e.g., an electromagnetic sensor such as a Hall Effect-type sensor, an optical sensor, a capacitive sensor, an inductive sensor, or a reed switch) located on the PCB 22 and embedded within the light head 12, and a magnet 32 located within the rotatable selector 40, wherein the spatial orientation of the magnet(s) 32 as the rotatable selector 40 is rotated will indicate to the sensor 30 the desired mode of operation of the light head 12 and/or the light source 20. Said another way, the magnet 32 will change orientation as the rotatable selector 40 is rotated, thus allowing the sensor 30 to read this orientation and communicate to the PCB 22 the desired mode of operation of the light source 20 corresponding with the present rotational position of the rotatable selector 40. A magnetic sensor arrangement has the benefit of allowing for infinite rotation of the rotatable selector 40 in either direction without the possibility of kinking, twisting, or other damage occurring to a connection wire. It should be understood that such a magnet and sensor arrangement could be used in additional orientations of a selector, dial, or switch, including but not limited to a depressible actuator, a linear slider or other non-circular movement shapes or directions corresponding with movement of the magnet plus actuator, slider, or selector. Seal ring 44 has an identical shape and functionality as seal ring 70, which will be described below in detail.

Turning back to the present embodiment, in one exemplary mode of operation, the rotatable selector 40 is able to be pulled outwardly in the direction shown by the straight arrow labeled 46 in FIG. 13, and then rotated by 90-degree steps in either a clockwise or counterclockwise rotational direction (as indicated by the additional, curved arrow in FIG. 13) to choose the desired light mode. In this embodiment, the button 42 located on the rotatable selector 40 (e.g., as shown in FIG. 2) can be actuated (e.g., depressed) to change an output mode. For example, the button 42 can be a push button that can be tapped to turn the selected light source 20 ON or OFF or pressed and held in a depressed position to change the intensity of the selected light source 20 (e.g., Low, Medium, and High intensity modes). In some examples, the button 42 can be pushed and held (e.g., for approximately 1 second) to cycle through different intensities of the selected light source 20. In another example of a mode of operation, for every predetermined amount of time that the button 42 is pushed and held (e.g., a half second, one second, or two seconds,), the light source 20 can step through low intensity, lower medium intensity, higher medium intensity, high intensity, then back to higher medium intensity, lower medium intensity, and low intensity, although additional ordering of intensities are possible.

Further, the light source 20 can be controlled to achieve various intermittent lighting modes. To achieve a blink mode (e.g., 2 Hz=120 bpm, 50% duty cycle, maximum intensity), the button 42 can be double-tapped with the light source 20 initially turned off. From the blink mode, the button 42 can be pressed and held (e.g., for approximately 1 second) to enter a beacon mode (e.g., 0.83 Hz=50 bpm, 5% duty cycle, maximum intensity). The button 42 can then be pressed a single additional time to turn off the light source 20.

In some examples according to the present disclosure, operating the button 42 can provide an effect independent from operating the rotatable selector 40. For example, adjusting the rotatable selector 40 to another color can be programmed to have no effect on the output mode of the light source 20, which is controlled only by the button 42.

Various embodiments of the lighting device 10 according to the present disclosure are capable of various light modes and intensities, as noted above. In the embodiments shown in the Figures, the respective light heads 12, 312 each include three LEDs: a first LED 24, 326 (e.g., for white light), a second LED 26, 324 (e.g., for infrared (IR) light), and a third LED 28, 322 (e.g., that is switchable between red, green, or blue light output). In alternative embodiments, more than one LED capable of different individual color outputs could be outfitted within the light head, IR and/or UV lights could be provided within the light head, and/or more than one white light could be provided within the light head, in any combination.

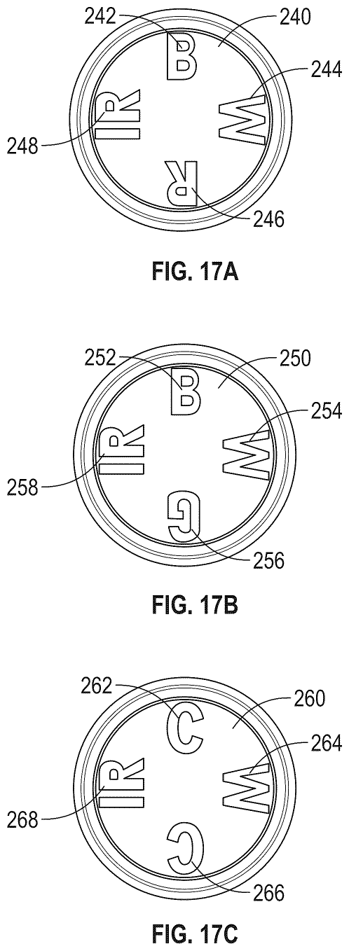

As shown in FIGS. 17A-17C, various boots (e.g., boots 240, 250, 260) can be affixed to the rotatable selector 40, according to the light mode selection desires or needs of the respective users. In each example, the boot includes four individual light mode indicators located at respective 90-degree rotatable positions from each other. FIG. 17A shows a military-focused option with a boot 240 having Blue, White, Red, and IR light options. In this example, the boot 240 includes a mode indicator 242 for blue light, a mode indicator 244 for white light, a mode indicator 246 for red light, and a mode indicator 248 for IR light. In this example, the mode indicators 242, 246 can be associated with use of the third LED 28, the mode indicator 244 can be associated with use of the first LED 24, and the mode indicator 248 can be associated with use of the second LED 26.

FIG. 17B shows an aviation-friendly option with a boot 250 having Blue, White, Green, and IR light options. In this example, the boot 250 includes a mode indicator 252 for blue light, a mode indicator 254 for white light, a mode indicator 256 for green light, and a mode indicator 258 for IR light. In this example, the mode indicators 252, 256 can be associated with use of the third LED 28, the mode indicator 254 can be associated with use of the first LED 24, and the mode indicator 258 can be associated with use of the second LED 26.

FIG. 17C shows a “user-controlled” option with a boot 260 having first user-selectable light color (“C” or “Color”)) option (e.g., blue, green, or red), a white light option, a second user- selectable light color (“C” “Color”) option (e.g., blue, green, or red), and an IR light option. In this example, the boot 260 includes a mode indicator 262 for the first user-selectable color light, a mode indicator 264 for white light, a mode indicator 266 for the second user-selectable color light, and a mode indicator 268 for IR light. In this example, the mode indicators 262, 266 can be associated with use of the third LED 28, the mode indicator 264 can be associated with use of the first LED 24, and the mode indicator 268 can be associated with use of the second LED 26. In some examples, default color assignments can be same as the military version of FIG. 17A (e.g., red and blue lights) or the aviation version of FIG. 17B (e.g., blue and green lights), with option to change one or both of these assigned colors or duplicate the programmed color. The color change procedures can include setting the rotatable selector 40 to a position of a desired mode indicator (e.g., the mode indicator 262 or the mode indicator 266). With the light source 20 turned off, the button 42 can be tapped 5 times within 2 seconds, and the last tap can be held (e.g., for approximately 1 second) until the light source 20 blinks a new color. The new color can be blinked in a predetermined sequence, for example, from a red light to a green light and from a green light to a blue light.

In some examples, the color assignments can be programmable. For example, a user can choose a desired number of possible colors (e.g., blue, green, red) and assign the selected colors to one or more of the mode indicators 262, 264, 266, or 268.

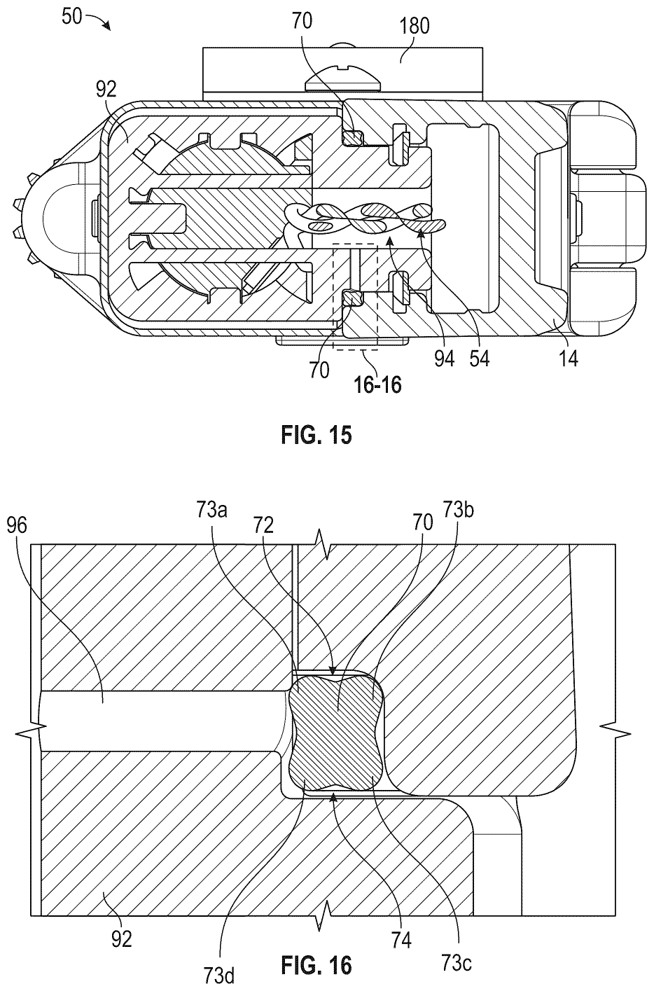

Yet another improvement embodied in the present lighting device 10 is the addition of a gas release port or vent hole 96 (as shown in FIGS. 15 and 16) which extends through the connection portion 92 of the rotatable joint 50. In this embodiment, the vent hole 96 mates with a seal ring 70 of annular shape and having an exterior profile 72 that is approximately “X”-shaped (i.e., an approximately “X”-shaped cross-sectional profile with four “points,” “lobes” or “arms” 73a-73d that extend out from a central portion of the seal ring 70). The seal ring 70 is fitted within a space 74 in the rotation joint 50 between the two connection portions 14, 92 that comprise the rotatable joint 50. The shape of the seal ring 70 allows for any gas that accumulates in the battery compartment 120 from the battery (-ies) (e.g., the first battery types 200, 210 and/or the second battery type 220) to travel up into the rotational joint 50, move through the vent hole 96, and then escape around the seal ring 70 to an exterior of the lighting device 10. In particular, once the pressure in the battery compartment 120 and rotational joint 50 builds up, the accumulated gas can travel through the vent hole 96 and then escape or “burp” around the seal ring 70 to the exterior of the lighting device 10 by temporarily deforming and/or displacing one or more of the arms 73a-73d of the seal ring 70 to allow the gas to move around those arm(s) 73a-73d to an exterior of the lighting device, while simultaneously maintaining the liquid resistance (e.g., IPX7 rating) of the battery compartment 120. Specifically, in this example, the “X”-shaped profile provides four small, approximately triangular-shaped gaps in the space 74 which allow space for the arms 73a-73d to deform and/or displace therein, thus allowing the built-up gases to escape therearound. The liquid resistance of the battery compartment 120 is maintained since outside water (or other liquid) pressure will quickly re-seat the seal ring 70 and thus seal the battery compartment 120 such that the liquid resistance of the lighting device 10 is retained. Said another way, the extending arms 73a-73d of the “X”-shaped profile of the seal ring 70 are able to displace and/or deform sufficiently to allow gas to escape from the interior of the battery compartment 120 of the lighting device 10 and then quickly recover their original shape to simultaneously prevent fluid ingress from the exterior of the lighting device 10. While the illustrated example shows the exterior profile 72 that includes the “X”-shaped profile, other examples can include the exterior profile 72 having different shaped profiles, including a “V”-shaped profile or a rectangular cross-section with two or three “arms” or “lobes” extending therefrom.

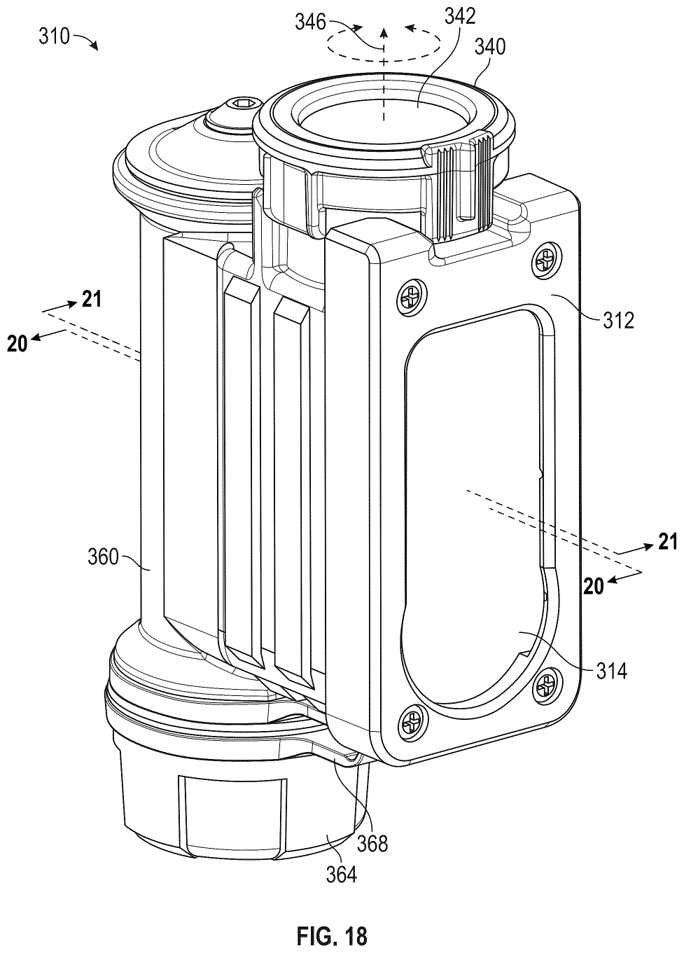

FIGS. 18-22 illustrate another embodiment of a lighting device 310 according to the present disclosure. As would be recognized by one of ordinary skill in the art, the lighting device 310 shares a number of components in common with and operates in a similar fashion to the examples illustrated and described previously. For the sake of brevity, these common features will not again be described below in detail. Rather, previous discussion of commonly named or numbered features, unless otherwise indicated, also applies to example configurations of the lighting device 310, mutatis mutandis.

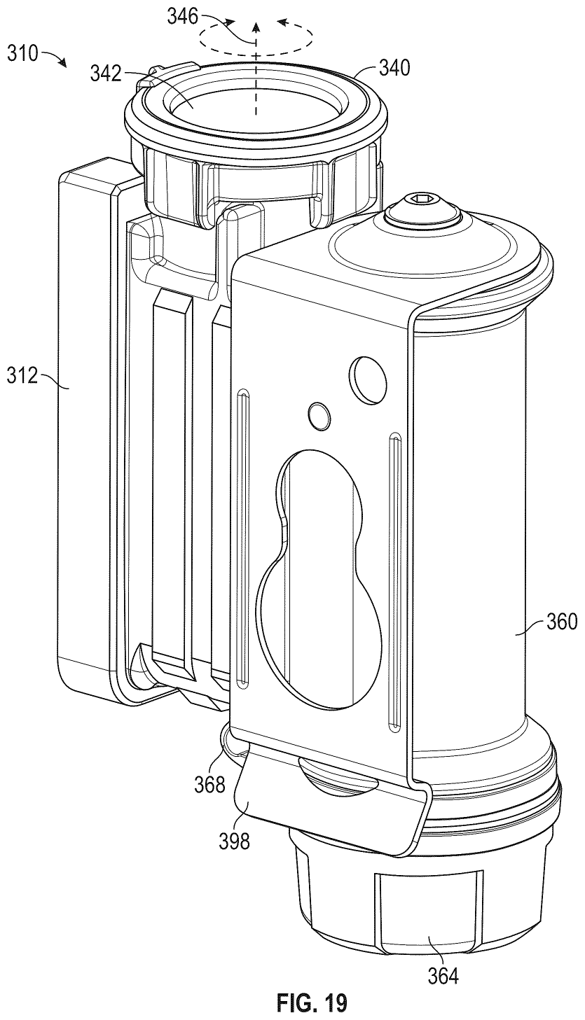

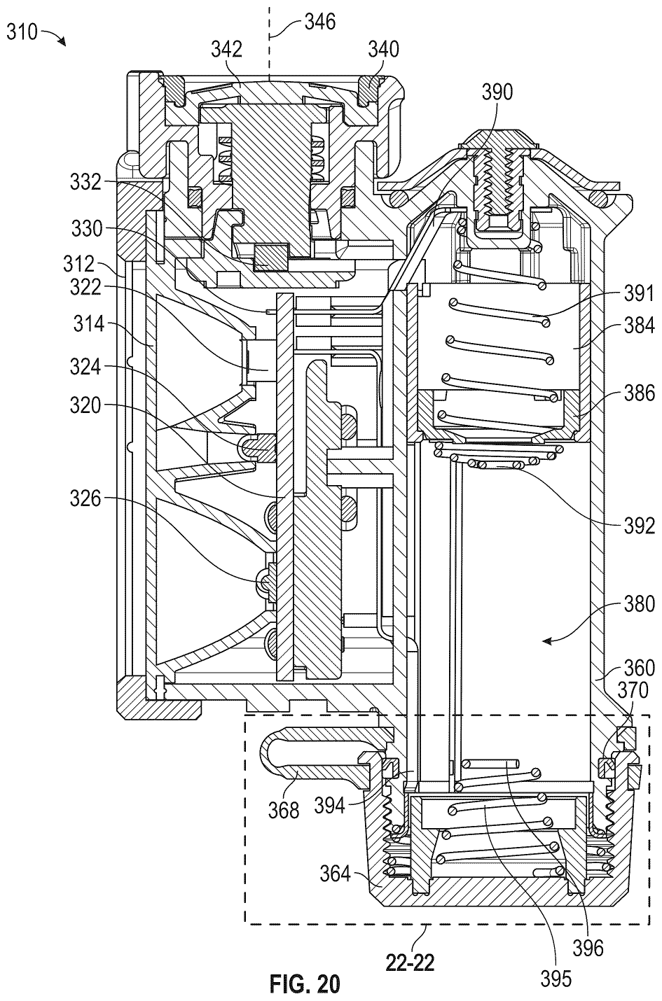

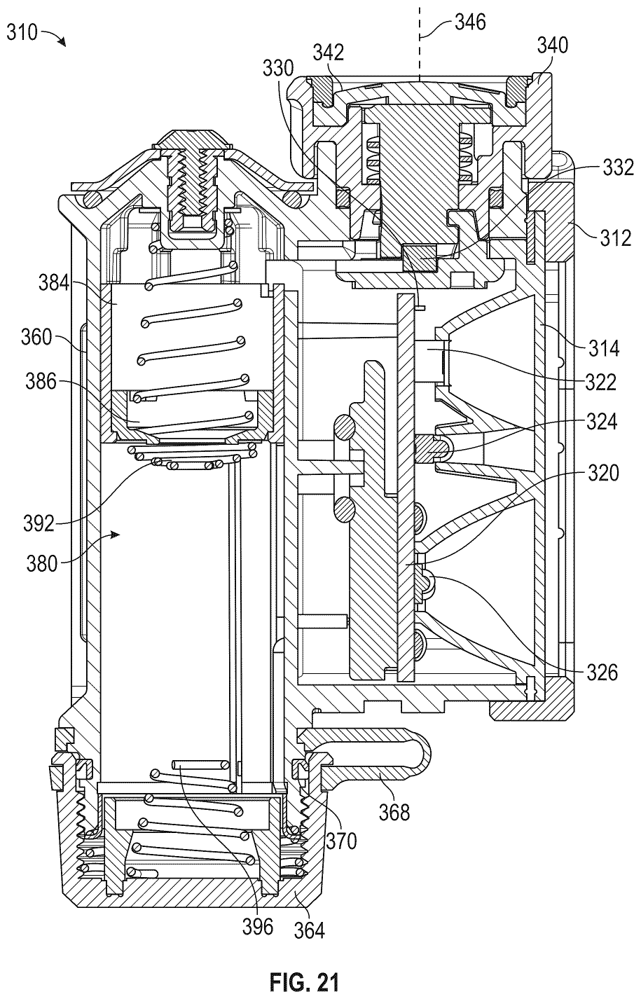

In this embodiment, the lighting device 310 includes a light head 312 that houses one or a plurality of light source(s) 314. The light head 312 is similar in construction to the light head 12 described previously, comprising a housing that protects the internal components thereof. The light source 314 includes a plurality of LEDs to produce different colors of light, such as white, infrared, red, green, or blue light, similar to the first LED 24, the second LED 26, and the third LED 28 described in connection with the previous embodiment. As shown in FIGS. 20 and 21, the light source 314 includes a PCB 320 that supports a first LED 326 (e.g., white light), a second LED 324 (e.g., IR light), and a third LED 322 (e.g., color light). A rotatable selector 340 can be pulled outwardly in the direction shown by the straight arrow labeled 346 in FIG. 18 and then rotated by 90-degree steps in either a clockwise or counterclockwise rotational direction about a rotational axis 346 (as indicated by the additional, curved arrows in FIG. 18) to choose the desired light mode. As discussed above, the selectable light mode options can include a military-focused version, an aviation-friendly version, and a “user controlled” version. The rotatable selector 340 incorporates a magnet 332 that works in conjunction with a sensor 330 (e.g., a Hall Effect-type sensor) mounted on the PCB 320. As the rotatable selector 340 is rotated, the spatial orientation of the magnet 332 changes relative to the sensor 330, which detects this change in orientation and communicates to the PCB 320 the desired mode of operation for the light source 314. Further, a button 342 can be pressed to control an output mode (e.g., a blink mode, a beacon mode, intensity adjustments, etc.) of the light source 314, as in the embodiment described above. In FIG. 19, the lighting device 310 includes a clip 398 attached to the body 360. Some examples of the lighting devices 10, 310 can include a stationary or slidable optical element (e.g., a focuser or diffuser) that is optionally attachable to the light head 312 and positionable over one or more of the LEDs 322, 324, 326 to create a more focused or diffuse beam of light emitted from the light source 314.

The lighting device 310 further includes a body 360 that is connected to the light head 312. In some examples, the body 360 can include a clip 398 that can be used to attach the lighting device 310 to a user's clothing (e.g., a belt, a cap, a shirt, etc.) or an additional object. The body 360 primarily serves as a battery housing and includes a battery compartment 380 that can be accessed by opening a battery cover 364, which is rotatably attached to the body 360 via a hinge 368. The battery cover 364 includes a threaded portion 372 that can threadably engage with a threaded portion 362 of the body 360. The battery compartment 380 can receive either a first battery type (e.g., an AA-sized battery) or a second battery type (e.g., a CR123-sized battery). With specific reference to FIG. 20, the battery compartment 380 includes contact extenders 390, 394 that are connected to the PCB 320 to provide power from a battery to the light source 314. The contact extender 390 is in contact with and electrically connected to a contact spring 391 that is supported on a guide piece 384 and includes a negative contact point 392 located at an end thereof. The contact extender 394 is in contact with and electrically connected to a contact spring 395 that includes a positive contact point 396 and is supported within a body of the battery cover 364. Thus, when the battery cover 364 is suitably closed from an open position, the positive contact point 396 can contact the battery within the battery compartment 380, and a battery circuit can be completed.

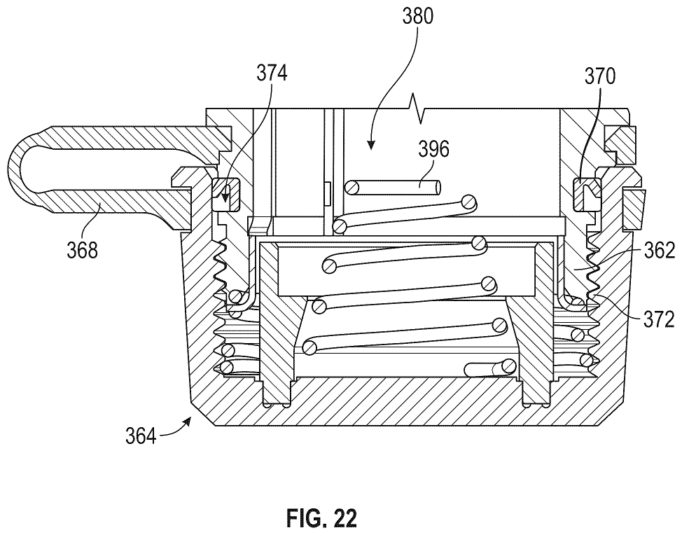

In some examples, the guide piece 384 can slide vertically (as oriented in FIG. 22) along a length of the battery compartment 380 to accommodate different battery types (e.g., lengths or heights, or stacks of two or more batteries). The guide piece 384 holds the negative contact point 392 at a predetermined level within the battery compartment 380, providing a stable reference position for electrical contact. For example, when a longer battery type (e.g., a AA-sized battery) is inserted into the battery compartment 380, the contact spring 391 can be compressed, and a seat 386 supporting the contact spring 391 can slide into the guide piece 384 (e.g., in a direction away from the battery cover 364). Thus, the longer battery type can fit within the battery compartment 380 for proper electrical contact. When a shorter battery type (e.g., a CR123-sized battery) is inserted into the battery compartment 380, the seat 386 can contact an end of the guide piece 384, and the contact extender 390 can be extended to bring the negative contact point 392 in contact with the shorter battery type. Accordingly, the lighting device 310 can flexibly accommodate various battery form factors without requiring any manual adjustment by the user.

As shown in FIGS. 20-22, the battery cover 364 includes a seal 370 that includes a “V”-shaped cross-sectional profile. The seal 370 is stretched and radially mounted around a bottom end of the body 360 above the threaded portion 362. The seal 370 then sits within a groove 374 of the body 360, thus creating a liquid-resistant seal between the battery cover 364 and the battery compartment 380 when the battery cover 364 is suitably closed. The geometry of the seal 370 (owing to its approximate “V”-shape in cross section) creates the liquid-resistant seal (e.g., a rating of IPX7) while also allowing for gases or heat that are generated within the battery compartment 380 to be vented exterior to the lighting device 310, in a similar way to how the X-shaped seal ring 70 of the embodiment of FIGS. 1-16 operates. Said another way, the seal 370 creates a bi-directional liquid-resistant but uni-directional gas-permeable seal (i.e., in a direction from the interior of the body 360 to the exterior thereof). Further, the seal 370 can provide a sealing barrier between an exterior of the battery cover 364 and the components housed therein that are susceptible to damage from outside contaminants, such as for example dust or moisture, while permitting for appropriate venting of the battery compartment 380 to the exterior of the lighting device 310 via the seal 370. In the illustrated example, the seal 370 is fully enclosed within the body 360 and provides a low-profile sealing arrangement for the components housed within the battery cover 364 that is not visible from the exterior of the body 360 of the lighting device 310.

It should be understood that while the above improvements are described in the context of lighting devices, these improvements are equally useful in and applicable to any other type of electronic device.

Although exemplary implementations of the herein described apparatus(es), system(s), and/or method(s) have been described in detail above, those skilled in the art will readily appreciate that many additional modifications are possible in the exemplary embodiments without materially departing from the novel teachings and advantages of the herein described systems and methods. Accordingly. these and all such modifications are intended to be included within the scope of the herein described systems and methods. The herein described systems and methods may be better defined by the following exemplary claims.

1. A lighting device comprising:
a light source;
a battery compartment electrically connected to the light source, the battery compartment adapted to alternatively receive a first number, equal to or greater than one, of units of a first battery size, or a second number, equal to or greater than one, of units of a second battery size, wherein the first number and the second number are not identical; and
wherein the first battery size and the second battery size are electrically connected to the light source through at least one non-identical contact point.

2. The lighting device of claim 1, wherein the first number of units is one and the second number of units is two.

3. The lighting device of claim 1, wherein the first number of units of the first battery size is equal to or greater than two, and the battery compartment further comprises
a first contact point adapted to make an electrical connection with a first terminal type of a first unit of the first battery size,
a second contact point adapted to make an electrical connection with a second terminal type of the first unit of the first battery size,
a third contact point adapted to make an electrical connection with a first terminal type of at least one unit of the second battery size,
a fourth contact point adapted to make an electrical connection with a second terminal type of the at least one unit of the second battery size,
a fifth contact point adapted to make an electrical connection with the first terminal type of a second unit of the first battery size,
a sixth contact point adapted to make an electrical connection with the second terminal type of the second unit of the first battery size,
a first contact extender that electrically connects the first contact point to the third contact point,
a second contact extender that electrically connects the second contact point to the fifth contact point, and
a third contact extender that electrically connects the fourth contact point to the sixth contact point.

4. The lighting device of claim 3, wherein the first, third, and fifth contact points are adapted to make an electrical connection with a positive polarity terminal and the second, fourth, and sixth contact points are adapted to make an electrical connection with a negative polarity terminal.

5. The lighting device of claim 3, the lighting device further comprising a body, the body including a battery cover that opens and closes to provide access to the battery compartment, wherein the second contact extender is supported on or located in the battery cover.

6. The lighting device of claim 5, wherein the third contact extender comprises a first portion that is located in the battery compartment and a second portion that is supported on or located in the battery cover, wherein the first portion of the third contact extender and the second portion of the third contact extender are alternatively positionable in contact with each other or separable from each other based on a position of the battery cover.

7. The lighting device of claim 6, wherein the first portion of the third contact extender includes a leg located along a sidewall of the battery compartment.

8. The lighting device of claim 6, wherein the first portion of the third contact extender includes a tab having an angled surface and the second portion of the third contact extender includes an angled portion that engages with the tab when the battery cover is closed.

9. The lighting device of claim 3, the lighting device further comprising a body, the body including a battery cover that opens and closes to provide access to the battery compartment, wherein the third contact extender comprises a first portion that is located in the battery compartment and a second portion that is supported on or located in the battery cover, wherein the first portion of the third contact extender and the second portion of the third contact extender are alternatively positionable in contact with each other or separable from each other based on a position of the battery cover.

10. The lighting device of claim 9, wherein the first portion of the third contact extender includes a leg located along a sidewall of the battery compartment.

11. The lighting device of claim 10, wherein the first portion of the third contact extender includes a tab having an angled surface and the second portion of the third contact extender includes an angled portion that engages with the tab when the battery cover is closed.

12. The lighting device of claim 9, wherein the first portion of the third contact extender includes a tab having an angled surface and the second portion of the third contact extender includes an angled portion that engages with the tab when the battery cover is closed.

13. The lighting device of claim 1, wherein the battery compartment further comprises a plurality of ribs configured to support the received units of the first battery size or second battery size.

14. The lighting device of claim 1, further comprising a body, a light head, and a rotation joint that connects the body and the light head together such that the light head can rotate with respect to the body, wherein the light source is located within the light head.

15. A lighting device comprising:
a printed circuit board (PCB);
a light source;
an electromagnetic sensor in the form of a Hall Effect-type sensor that is in electrical connection with the PCB and the light source; and
a selector including a magnet attached thereto, the selector being rotatable about a rotation axis to change an orientation of the magnet, wherein the electromagnetic sensor is configured to receive the signal based on the orientation of the magnet with respect to the rotation axis and provide a signal to the PCB to change a status of the light source based on the orientation of the magnet.

16. (canceled)

17. (canceled)

18. The lighting device of claim 15, wherein the light source comprises two or more light emitting diodes (LEDs), and the status of the light source that is changeable via movement of the selector is selection between activation of a first one of the LEDs and activation of a second one of the LEDs.

19. The lighting device of claim 15, further comprising a light head and a body, the light head being pivotable with respect to the body.

20. The lighting device of claim 15, further comprising a body, wherein the selector is attached to the body and configured to be pulled away from the body and rotated relative to the body to change the orientation of the magnet.

21. A lighting device comprising:
a body comprising an interior that includes a battery compartment;
a light head; and
a rotation joint, the light head being rotatably connected to the body via the rotation joint, the rotation joint comprising a vent hole and further comprising a vent seal that extends around the entirety of the rotation joint;
wherein the vent hole extends between the interior of the body and the vent seal, the vent seal being-configured to allow for gases to escape from the interior of the body and simultaneously provide the lighting device with resistance to the ingress of liquids from an exterior of the lighting device.
